(19) United States
(12) Patent Application Publication
(10) Pub. No.: US 2002/0196800 A1
(43) Pub. Date: Dec. 26, 2002

(54) Method for operating a communications network

(76) Inventor: Manfred Angermayr, Muenchen (DE)

Correspondence Address: BELL, BOYD & LLOYD, LLC, P. O. BOX 1135, CHICAGO, IL, 60690-1135, US

(21) Appl. No.: 10/078,841

(22) Filed: Feb. 19, 2002

(30) Foreign Application Priority Data
Feb. 20, 2001 (DE) 101 08 052.2

(51) Int. Cl. H04L 12/28

(52) U.S. Cl. 370/431

(57) ABSTRACT

A method for operating a communications network having a number of nodes in accordance with ITU Standard Q704, wherein when the message transfer part of a node is restarted, the MTP restart procedure in accordance with the protocol is initiated by this node only with those adjacent nodes in which the MTP restart procedure is implemented.

### BACKGROUND OF THE INVENTION

The present invention relates to a method for operating a communications network having a number of nodes in accordance with ITU Standard Q704.

The signaling between switching centers for setting up and clearing user data links and for controlling services in an ISDN telecommunications network is carried out on the basis of the ITU-T signaling system No. 7 defined by the International Telecommunications Union (ITU). This defines the internationally introduced basis for interchanging signaling messages between digital switching centers. The signaling process is carried out using signaling method No. 7 in separate 64 kbits/s channels, which can be dealt with like user channels. They can, thus, be transmitted through the switching networks.

If a link between two switching centers is interrupted or when a new switching center or a new node is taken into use in the telecommunications network, its message transfer part (MTP) must be restarted in order to include the corresponding node in the user data traffic (once again).

ITU Standard Q704 defines a specific communications sequence for protection of a node in a communications network, whose MTP has been restarted or is currently being started (the MTP restart procedure). The procedure in accordance with the protocol provides the starting MTP with sufficient time for adequate activation of links and for interchanging routing information with the adjacent areas in the network (the adjacent nodes). The completion of this procedure is signaled by transmitting a specified message, the “traffic restart allowed” message, to each of the adjacent nodes.

The procedure in accordance with the protocol is based on the precondition that all the nodes in the network “have” this; that is to say, it is implemented in all the nodes in the network. However, as is known, communications networks are in practice normally composed of parts and sections of different age and, hence, also with different implementation standards. The MTP restart procedure is, thus, in many cases not implemented in some areas of communications networks that are in use in practice; that is to say, the assumption made in the Standard is not true.

If the MTP restart procedure were nevertheless to be activated in a node during the starting of its MTP, then the time period before the MTP is ready to transport messages would be lengthened considerably, for the following reasons:

When starting its own MTP (also referred to as “own point restart”), the MTP must wait, in accordance with Q704 timer T18, for approximately 30 seconds for the “traffic restart allowed” message from all its neighbors, before it transmits its own routing information, terminated by its own “traffic restart allowed” message, and then starts to transmit user data traffic. The neighbor of a node which is being restarted transmits its routing information, terminated by its “traffic restart allowed” message, and then waits, in accordance with Q704 timer T21 for approximately 60 seconds for the “traffic restart allowed” message from the opposite end, before the traffic is started. (This process is referred to as “adjacent point restart”.) Depending on whether its own MTP or that of a neighbor node is being restarted, the Standard therefore provides a waiting time of 30 or 60 seconds respectively, before starting user data traffic following the MTP restart procedure.

It is obvious that a node in a communications network in which this procedure is not implemented will never be able to transmit the message in accordance with the protocol for which the adjacent nodes are waiting. Each of the adjacent nodes thus waits for the time intervals without being able to receive any message at all. This unnecessarily lengthens the system down times. For this reason, when ITU Standard Q704 has been used in existing communications networks until now, the MTP restart procedure is activated only when it is known that it has been implemented in all the nodes in that network.

However, this approach has disadvantages, since the MTP restart procedure ensures, in a simple and reliable manner, synchronization of operation between mutually interacting switching centers before the actual user data traffic starts. If it is dispensed with, this is evident only after the user data traffic starts, when a node has been in a restart or start-up phase and was not ready for traffic, and the corresponding part of the traffic must be repeated once this node has completed its starting phase.

The present invention is, thus, directed toward an improved method of this generic type, which allows efficient network operation without unnecessarily long system downtimes while making as much use as possible of the advantages of the MTP restart procedure.

### SUMMARY OF THE INVENTION

The present invention includes the fundamental idea that, when restarting the message transfer part of a network node, the MTP restart procedure in accordance with the protocol is initiated and carried out only with those adjacent nodes which “have” it. Furthermore, the present invention includes the idea of storing appropriate information relating to the implementation of this procedure in each of the adjacent nodes in the network. This allows autonomous network operation in the corresponding starting phases without any specific external control processes or internal communication processes to record the implementation standard of the individual nodes.

In one preferred embodiment, the relevant information for each adjacent node is stored in a database for each node. Specifically an attribute which indicates the implementation or non-implementation of the MTP restart procedure in the respective node is stored in the database for each linkset which uniquely identifies an adjacent node.

In another embodiment of the proposed method and system, this information is stored in a central database for all the nodes in the communications network (or at least a relatively large section of it).

This information allows the user data traffic with those adjacent nodes which are not designed to carry out the MTP restart procedure to be started essentially immediately after activation of the links in the corresponding linkset. In practice, the traffic can be started, at the latest, directly after receiving “traffic restart allowed” messages from those adjacent nodes in which the MTP restart procedure is implemented, and which are thus able to transmit such a message.

On the other hand, on restarting the MTP of a node which is not itself designed to carry out the MTP restart procedure, the adjacent nodes start the user data traffic essentially immediately by activation of the links in their corresponding linkset; in particular, that is to say, immediately after transmitting their routing information, which is terminated by the “traffic restart allowed” message, to the starting node. As such, there is no need to implement a waiting time for this node.

Additional features and advantages of the present invention are described in, and will be apparent from, the following Detailed Description of the Invention and the Figures.

### DETAILED DESCRIPTION OF THE INVENTION

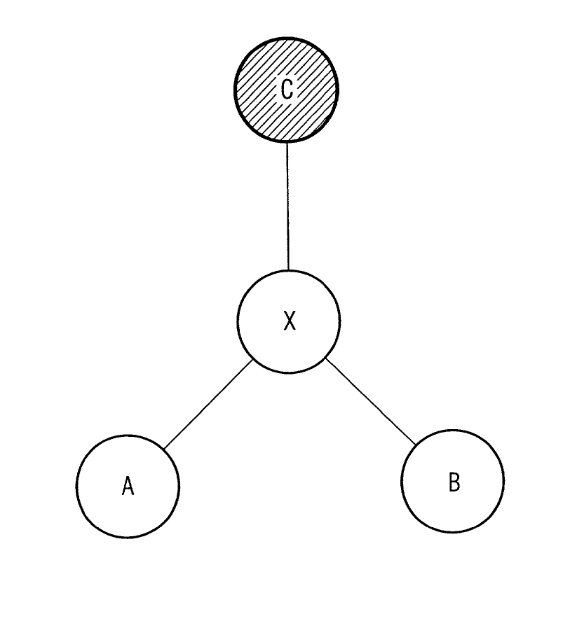

FIG. 1 shows, roughly and schematically, a section of a communications network, which is referred to in short as an “MTP network”, in which the present invention can be used; namely, four nodes A, B, C and X, and their links to one another. It is assumed that the MTP restart procedure is implemented in the nodes A and B, but not in the node C. The method according to the present invention is used in the node X, so that this node is configured such that the MTP restart is activated for the adjacent nodes A and B, but is deactivated for the adjacent node C. In order to explain the present invention, three different operating states are assumed in the following text, with the procedures in accordance with the method being described.

In the first example, it is assumed that the node X is being restarted, and that its MTP is being started. Once the links to A, B and C have been activated, the node X waits until (but for no longer than the time interval T18=30 seconds in accordance with the protocol) the adjacent nodes A and B have transmitted their routing information to it and have signaled, via the “traffic restart allowed” message (TRA), that they have completed the transmission of the routing information. Node X therefore waits only for the TRAs from A and B, since an attribute which represents the implementation of the MTP restart procedure is stored in an appropriate database for the linkset which defines these two nodes.

However, the linkset which represents the node C contains an attribute which represents non-implementation of the MTP restart procedure. The node X, therefore, does not wait for a TRA from the node C, since it is clear from the information stored in the database that there is no purpose in waiting for any such message. Thus, as soon as A and B have transmitted their TRAs, the node X can itself immediately transmit routing information, terminated by its own TRA, and can start to transmit traffic.

In a second example, it is assumed that the node A is being restarted or is being started. Once the links to the node A have been activated, the node X transmits its routing information, terminated with a TRA, to the node A. Since the MTP restart is activated with respect to the node A in the configuration of the node X, X does not start its reception of data traffic until (but for a maximum of T21=60 seconds) the node A has itself signaled, by transmitting its TRA, that it is ready to receive traffic.

In the third example, it is assumed that the node C is being restarted or is being started. Once the links to the node C have been activated, the node X transmits its routing information, terminated by a TRA, to the node C. Since, on the basis of the configuration of the node X, the MTP restart is deactivated with respect to the node C, the node X starts data traffic with the node C immediately. In this case, the corresponding attribute in the linkset specifying the node C indicates that the node C does not have MTP restart and therefore cannot transmit a TRA.

Although the present invention has been described with reference to specific embodiments, those of skill in the art will recognize that changes may be made thereto without departing from the spirit and scope of the invention as set forth in the hereafter appended claims.

1. A method for operating a communications network having a plurality of nodes in accordance with an ITU Standard Q704 protocol, the method comprising the steps of:
determining when a message transfer part of a node is restarted; and
initiating, by the node, an MTP restart procedure in accordance with the protocol only with the adjacent nodes in which the MTP restart procedure is implemented.

2. A method for operating a communications network as claimed in claim 1, the method further comprising the step of storing, in a database for each node, an attribute, which indicates one of implementation and non-implementation of the MTP procedure in the respective node, for each linkset which identifies an adjacent node.

3. A method for operating a communications network as claimed in claim 1, the method further comprising the step of storing, in a central database, an attribute, which indicates one of implementation and non-implementation of the MTP procedure in the respective node, for all the nodes in at least a section of the communications network.

4. A method for operating a communications network as claimed in claim 1, wherein communications traffic with the adjacent nodes in which the MTP restart procedure is not implemented starts essentially immediately after activation of links in a corresponding linkset, at a latest point in time after receiving “traffic restart allowed” messages from the other adjacent nodes.

5. A method for operating a communications network as claimed in claim 1, wherein, upon restarting the message transfer part of a node which is not itself designed to carry out the MTP restart procedure, the adjacent nodes start communications traffic to the node essentially immediately after activation of links in a corresponding linkset, immediately after transmitting routing information, which is terminated by a “traffic restart allowed” message, to a starting node.
